(19) United States
(12) Patent Application Publication
(10) Pub. No.: US 2024/0376964 A1
(43) Pub. Date: Nov. 14, 2024

(54) HYBRID POWER SYSTEM AND VEHICLE

(71) Applicant: CHERY AUTOMOBILE CO., LTD., Wuhu (CN)

(72) Inventors: Hengxian ZHANG, Wuhu (CN); Zhiguang ZHOU, Wuhu (CN); Yuanlong YE, Wuhu (CN); Lizhen GENG, Wuhu (CN); Yanan LI, Wuhu (CN); Dong HUANG, Wuhu (CN)

(21) Appl. No.: 18/692,721

(22) PCT Filed: Apr. 25, 2022
(86) PCT No.: PCT/CN2022/088905

§ 371 Date: Mar. 15, 2024

(30) Foreign Application Priority Data
Oct. 27, 2021 (CN) 202111253291.1

(51) Int. Cl. F16H 3/089; B60K 6/28; B60K 6/36; B60K 6/40; B60K 6/442; B60K 6/54

(52) U.S. Cl. CPC F16H 3/089; B60K 6/28; B60K 6/36; B60K 6/40; B60K 6/442; B60K 6/54; B60Y 2200/92

(57) ABSTRACT

The present application provides a hybrid power system and a vehicle. The hybrid power system includes a gearbox, an engine, a first motor, and a second motor; wherein the gearbox includes a first input shaft, an output shaft, a second input shaft, a first speed change mechanism, and a second speed change mechanism, wherein the first input shaft is connected to the output shaft via the first speed change mechanism, and the second input shaft is connected to the output shaft via the second speed change mechanism; the engine and the first motor are drivingly connected to the first input shaft; and the second motor is drivingly connected to the second input shaft.

The present disclosure is a U.S. national phase application based on PCT/CN2022/088905, filed on Apr. 25, 2022, which claims priority to Chinese Patent Application No. 202111253291.1, filed on Oct. 27, 2021 and entitled “HYBRID SYSTEM AND VEHICLE”, the contents of which are incorporated herein by reference in their entireties.

### TECHNICAL FIELD

The present disclosure relates to the technical field of automobiles, and in particular, to a hybrid power system and a vehicle.

### BACKGROUND

Most traditional automobiles use fossil fuels (such as gasoline and diesel oil) to supply power for engines, and their exhaust gas pollutes the environment. Therefore, it is urgent to replace fossil fuels with new pollution-free energy sources (such as electric energy) to provide power for automobiles, and the automobiles equipped with hybrid power systems are the trend of development.

### SUMMARY

Embodiments of the present disclosure provide a hybrid power system and a vehicle.

According to some embodiments of the present disclosure, a hybrid power system is provided. The hybrid power system includes: a gearbox, an engine, a first motor, and a second motor, wherein the gearbox includes a first input shaft, an output shaft, a second input shaft, a first speed change mechanism, and a second speed change mechanism, the first input shaft is connected to the output shaft via the first speed change mechanism, and the second input shaft is connected to the output shaft via the second speed change mechanism; the engine and the first motor are drivingly connected to the first input shaft; and the second motor is drivingly connected to the second input shaft.

In some embodiments, the first speed change mechanism includes a first gear train and a first synchronizer, wherein an input gear of the first gear train is sleeved on the first input shaft, and an output gear of the first gear train is coaxially connected to the output shaft; and the first synchronizer is sleeved on the first input shaft and is configured to cause the input gear of the first gear train to be connected to the first input shaft or cause the input gear of the first gear train to be disconnected from the first input shaft.

In some embodiments, the second speed change mechanism includes a second gear train, wherein an input gear of the second gear train is coaxially connected to the second input shaft, and an output gear of the second gear train is coaxially connected to the output shaft; and the first input shaft is coaxially spaced from the second input shaft, the input gear of the second gear train is disposed at one end of the second input shaft opposite to the first input shaft, and the first synchronizer is configured to cause at most one of the input gear of the first gear train and the input gear of the second gear train to be connected to the first input shaft.

In some embodiments, the first speed change mechanism further includes a third gear train, wherein an input gear of the third gear train is sleeved on the first input shaft, and an output gear of the third gear train is coaxially connected to the output shaft; and the first synchronizer is disposed between the input gear of the first gear train and the input gear of the third gear train, and the first synchronizer is configured to cause at most one of the input gear of the first gear train and the input gear of the third gear train to be connected to the first input shaft.

In some embodiments, the second speed change mechanism includes a second gear train, wherein an input gear of the second gear train is coaxially connected to the second input shaft, and an output gear of the second gear train is coaxially connected to the output shaft.

In some embodiments, the first input shaft is coaxially spaced from the second input shaft; and the second speed change mechanism further includes a support shaft, wherein a first end of the support shaft is movably connected to a first end of the first input shaft in a circumferential direction, a second end of the first input shaft is drivingly connected to the engine, and a second end of the support shaft is coaxially connected to the second input shaft; and an input gear of the third gear train is sleeved on the support shaft.

In some embodiments, a sleeve coaxially connected to the support shaft is arranged at the first end of the support shaft, one end of the sleeve is open, and the sleeve is opposite to the first end of the first input shaft; and a bearing is arranged in the sleeve, wherein an outer ring of the bearing is connected to an inner wall of the sleeve, and an inner ring of the bearing is sleeved on the first end of the first input shaft.

In some embodiments, the second speed change mechanism further includes a clutch disposed between the input gear of the second gear train and the second motor.

In some embodiments, the second speed change mechanism includes a second gear train, a third gear train, and a second synchronizer; an input gear of the second gear train and an input gear of the third gear train are both coaxially connected to the second input shaft, and an output gear of the second gear train and an output gear of the third gear train are sleeved on the output shaft; the first input shaft is coaxially spaced from the second input shaft, the first synchronizer is configured to cause at most one of the input gear of the first gear train and the input gear of the second gear train to be connected to the first input shaft; and the second synchronizer is sleeved on the output shaft and is configured to be drivingly connected to at most one of the output gear of the second gear train and the output gear of the third gear train.

In some embodiments, the gearbox further includes a fourth gear train, wherein the first motor is coaxially connected to an input gear of the fourth gear train, and an output gear of the fourth gear train is coaxially connected to the first input shaft.

In some embodiments, the hybrid power system further includes a power supply assembly, wherein the power supply assembly includes a battery and two inverters, the two inverters being connected to the battery, the first motor being connected to one of the two inverters, and the second motor being connected to the other of the two inverters.

According to some embodiments of the present disclosure, a vehicle is provided. The vehicle includes the hybrid power system as described above.

### BRIEF DESCRIPTION OF THE DRAWINGS

For clearer illustration of the technical solutions in the embodiments of the present disclosure, the drawings required to be used in the description of the embodiments are briefly introduced below. It is apparent that the drawings in the description below are only for some embodiments of the present disclosure, and for those of ordinary skill in the art, other drawings can be acquired according to the drawings without creative efforts.

FIG. 1 is a schematic structural diagram of a hybrid power system according to some embodiments of the present disclosure;

FIG. 2 is a schematic structural diagram of a hybrid power system according to some embodiments of the present disclosure;

FIG. 3 is a schematic structural diagram of a hybrid power system according to some embodiments of the present disclosure;

FIG. 4 is a schematic structural diagram of a hybrid power system according to some embodiments of the present disclosure;

FIG. 5 is a schematic diagram of the power transfer of a hybrid power system in an electric-only mode according to some embodiments of the present disclosure;

FIG. 6 is a schematic diagram of the power transfer of a hybrid power system in an engine-only mode according to some embodiments of the present disclosure;

FIG. 7 is a schematic diagram of the power transfer of a hybrid power system in a hybrid mode according to some embodiments of the present disclosure;

FIG. 8 is a schematic diagram of the power transfer of a hybrid power system in a hybrid mode according to some embodiments of the present disclosure;

FIG. 9 is a schematic diagram of the power transfer of a hybrid power system in a hybrid mode according to some embodiments of the present disclosure;

FIG. 10 is a schematic diagram of the power transfer of a hybrid power system in a power recovery mode according to some embodiments of the present disclosure;

FIG. 11 is a schematic diagram of the power transfer of a hybrid power system in an electric-only mode according to some embodiments of the present disclosure;

FIG. 12 is a schematic diagram of the power transfer of a hybrid power system in an engine-only mode according to some embodiments of the present disclosure;

FIG. 13 is a schematic diagram of the power transfer of a hybrid power system in a hybrid mode according to some embodiments of the present disclosure;

FIG. 14 is a schematic diagram of the power transfer of a hybrid power system in a hybrid mode according to some embodiments of the present disclosure;

FIG. 15 is a schematic diagram of the power transfer of a hybrid power system in a hybrid mode according to some embodiments of the present disclosure; and

FIG. 16 is a schematic diagram of the power transfer of a hybrid power system in a power recovery mode according to some embodiments of the present disclosure.

### DETAILED DESCRIPTION

For clearer descriptions of the objectives, technical solutions, and advantages of the present disclosure, the embodiments of the present disclosure are further described in detail below with reference to the accompanying drawings.

Unless otherwise defined, technical or scientific terms used herein shall have the ordinary meaning as understood by those of ordinary skill in the art to which the present disclosure belongs. “First”, “second”, “third”, and other similar words, as used in the specification and in the claims of the patent application of the present disclosure, do not indicate any order, quantity, or importance, but are merely defined to distinguish different components. Likewise, “a”, “an” or other similar words do not indicate a limitation of quantity, but rather the presence of at least one. “Include”, “comprise” or other similar words mean that the elements or objects stated before “include” or “comprise” encompass the elements or objects and equivalents thereof listed after “include” or “comprise”, but do not exclude other elements or objects. “Connecting”, “connected”, or other similar words are not limited to physical or mechanical connections, but may include electrical connections, whether direct or indirect. “Up”, “down”, “left”, “right”, “top”, “bottom”, and the like are merely defined to indicate relative positional relationships. In the case that the absolute position of a described object changes, the relative position relationship may also change accordingly.

In some practice of related art, a hybrid power system is provided in a vehicle. The system includes an engine, a motor, and a gearbox, wherein the gearbox includes an input shaft and an output shaft, and the input shaft is drivingly connected to the output shaft via at least one speed change mechanism. The engine and the motor are drivingly connected to the input shaft, such that the kinetic energy is transmitted to the output shaft via the input shaft to drive the wheels to rotate.

However, the engine and the motor are drivingly connected to the input shaft, in the case that one of the power sources works alone, the other power source is dragged by the input shaft to rotate, thereby causing energy loss. And at least one speed change mechanism is arranged between the input shaft and the output shaft, such that the structure of the gearbox is more complex.

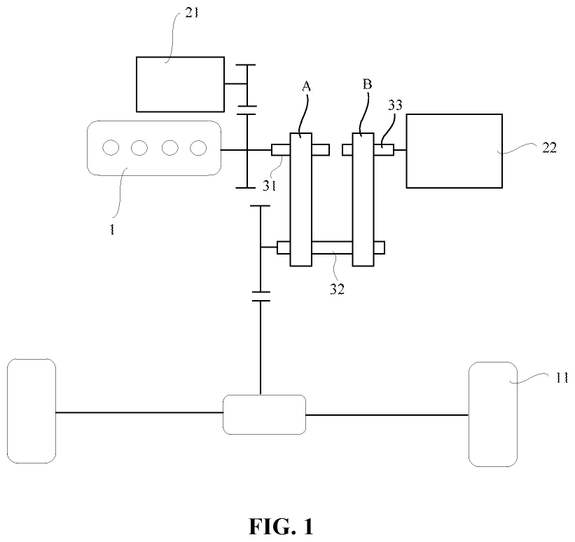

FIG. 1 is a schematic structural diagram of a hybrid power system according to some embodiments of the present disclosure. As shown in FIG. 1, the hybrid power system includes a gearbox, an engine 1, a first motor 21, and a second motor 22.

As shown in FIG. 1, the gearbox includes a first input shaft 31, an output shaft 32, a second input shaft 33, a first speed change mechanism A, and a second speed change mechanism B, wherein the first input shaft 31 and the output shaft 32 are connected via the first speed change mechanism A, and the second input shaft 33 and the output shaft 32 are connected via the second speed change mechanism B.

As shown in FIG. 1, the engine 1 and the first motor 21 are drivingly connected to the first input shaft 31, and the second motor 22 is drivingly connected to the second input shaft 33.

In the hybrid power system provided in the embodiments of the present disclosure, the first input shaft is connected to the output shaft of the gearbox via the first speed change mechanism, the second input shaft is connected to the output shaft of the gearbox via the second speed change mechanism, and the kinetic energy output by the engine and the two motors is transmitted to the output shaft through the two speed change mechanisms, such that the purpose of driving a vehicle to travel is achieved. Because the gearbox only uses two speed change mechanisms connected to the corresponding input shaft and output shaft, there is no other redundant structures, and the overall structure of the gearbox is simpler. In the single motor mode that only a motor needs to work alone, only the second motor needs to work, and the power of the second motor is directly transmitted to the second input shaft, such that the engine and the first motor are not directly dragged by the second input shaft to rotate, and the energy loss is avoided, thereby increasing the transmission efficiency.

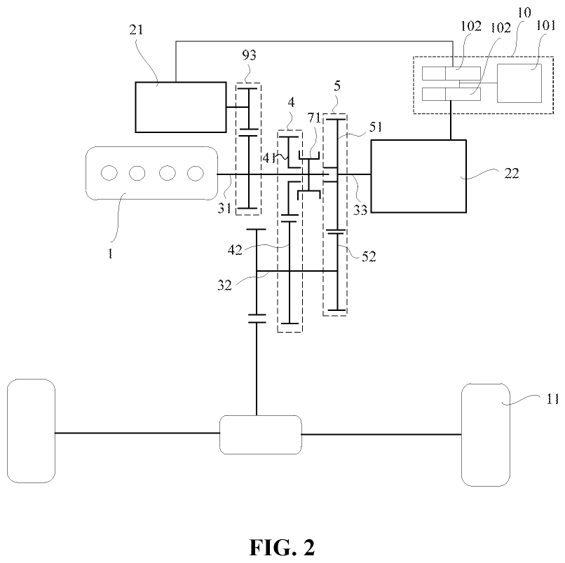

FIG. 2 is a schematic structural diagram of a hybrid power system according to some embodiments of the present disclosure. As shown in FIG. 2, the first speed change mechanism includes a first gear train 4 and a first synchronizer 71.

As shown in FIG. 2, an input gear 41 of the first gear train 4 is sleeved on the first input shaft 31, and an output gear 42 of the first gear train 4 is coaxially connected to the output shaft 32.

The first synchronizer 71 is sleeved on the first input shaft 31, and the first synchronizer 71 is configured to cause the input gear 41 of the first gear train 4 to be connected to the first input shaft 31 or cause the input gear 41 of the first gear train 4 to be disconnected from the first input shaft 31.

In the above implementations, the engine 1 is drivingly connected to the first input shaft 31, such that the kinetic energy of the engine 1 is output to the first input shaft 31, the first input shaft 31 is drivingly connected to the output shaft 32 via the first gear train 4, and the first synchronizer 71 is connected to the first input shaft 31. The first synchronizer 71 controls whether the input gear 41 of the first gear train 4 is connected to the first input shaft 31, and thus the kinetic energy output by the engine 1 is transmitted to the first gear train 4 and the output shaft 32 through the first input shaft 31 to drive the wheels 11.

In the case that the hybrid power system operates, the kinetic energy of the engine is transmitted to the output shaft through the first input shaft and the first gear train, and the kinetic energy of the second motor is transmitted to the output shaft through the second input shaft. In the process, the engine and the second motor do not drag the two input shafts to rotate simultaneously, such that the power source is prevented from being directly dragged to rotate, and the energy loss is avoided.

Meanwhile, the input gear 41 of the first gear train 4 is controlled to be disconnected from the first input shaft 31 by the first synchronizer 71. In this way, even if the power is transmitted to the first gear train 4 through the output shaft 32, the power is not transmitted to the first input shaft 31 continuously, that is, the first input shaft 31 is not indirectly dragged to rotate, and thus the engine is prevented from being dragged to rotate.

In the embodiments of the present disclosure, the first gear train 4 at least includes an input gear and an output gear, and the input gear is drivingly connected to the output gear, such that the power is transmitted to the output gear through the input gear.

In some embodiments, the input gear and the output gear of the first gear train 4 are directly engaged to achieve transmission connection between the input gear and the output gear. In some embodiments, at least one connecting gear is further arranged between the input gear and the output gear. For example, in the case that only one connecting gear is arranged, the connecting gear is engaged with the input gear and the output gear to achieve transmission connection between the input gear and the output gear.

It should be noted that the specific quantity of gears to be arranged in the first gear train 4 is determined according to actual demands. Because the quantity of gears arranged in the gear train affects the transmission ratio of the gear train, the quantity of gears in the gear train is adjusted according to the power demand of a vehicle.

In some embodiments, as shown in FIG. 2, the second speed change mechanism includes a second gear train 5, wherein an input gear 51 of the second gear train 5 is coaxially connected to the second input shaft 33, and an output gear 52 of the second gear train 5 is coaxially connected to the output shaft 32.

The second motor 22 is drivingly connected to the second input shaft 33, and the second input shaft 33 is drivingly connected to the output shaft 32 via the second gear train 5, such that the second motor 22 can transmit power to the output shaft 32 independently through the second gear train 5 to drive the wheels.

As shown in FIG. 2, the first input shaft 31 is coaxially spaced from the second input shaft 33, and the first synchronizer 71 is configured to cause at most one of the input gear 41 of the first gear train 4 and the input gear 51 of the second gear train 5 to be connected to the first input shaft 31.

The first synchronizer 71 is disposed between the input gear 41 of the first gear train 4 and the input gear 51 of the second gear train 5. The first synchronizer 71 is axially movable on the first input shaft 31, such that the first gear train 4 is drivingly connected to the first input shaft 31 in the case that the first synchronizer 71 approaches the first gear train 4 and is engaged with the input gear 41 of the first gear train 4.

In some embodiments, as shown in FIG. 2, the input gear 51 of the second gear train 5 is disposed at one end of the second input shaft 33 opposite to the first input shaft 31, and one end of the first input shaft 31 opposite to the second input shaft 33 is movably inserted into the input gear 51 of the second gear train 5.

Because the second input shaft 33 is coaxially spaced from the first input shaft 31, and one end of the first input shaft 31 opposite to the second input shaft 33 is movably inserted into the input gear 51 of the second gear train 5. In this way, the first synchronizer 71 is also engaged with the input gear 51 of the second gear train 5 in the case that the first synchronizer 71 approaches the second gear train 5, and thus the second gear train 5 can be drivingly connected to the first input shaft 31. The first synchronizer 71 can also be disconnected from both the input gear 41 of the first gear train 4 and the input gear 51 of the second gear train 5, that is, the first input shaft 31 and the output shaft 32 are disconnected.

In the case that the first synchronizer 71 is engaged with the first gear train 4, the power of the engine 1 is transmitted to the output shaft 32 through the first gear train 4. Because the second motor 22 is drivingly connected to the input gear 51 of the second gear train 5 directly, there is no need to connect the input gear 51 via the first synchronizer 71. In this way, the second motor 22 is controlled to work, such that the power of the second motor 22 is transmitted to the output shaft 32 through the second gear train 5. In the hybrid power system, the engine 1 and the second motor 22 transmit power to the output shaft 32 through two gear trains, respectively, so that another gear can be used to drive the vehicle, improving the use efficiency of the gear trains and realizing a multi-gear driving mode of the hybrid power system.

In the embodiments of the present disclosure, the second gear train 5 at least includes an input gear and an output gear, and the input gear is drivingly connected to the output gear, such that the power is transmitted to the output gear through the input gear.

In some embodiments, in the second gear train 5, the input gear and the output gear are directly engaged, In some embodiments, at least one connecting gear is arranged between the input gear and the output gear.

It should be noted that the specific quantity of gears to be arranged in the second gear train 5 is determined based on actual demands.

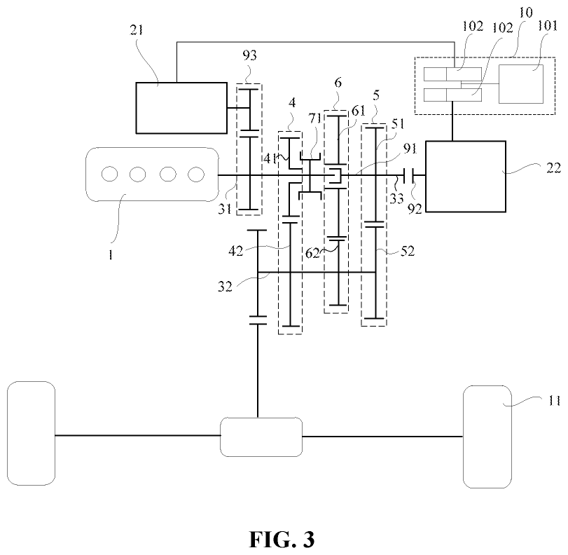

FIG. 3 is a schematic structural diagram of a hybrid power system according to some embodiments of the present disclosure. As shown in FIG. 3, the first speed change mechanism further includes a third gear train 6, wherein an input gear 61 of the third gear train 6 is sleeved on the first input shaft 31, and an output gear 62 of the third gear train 6 is coaxially connected to the output shaft 32.

As shown in FIG. 3, the first synchronizer 71 is disposed between the input gear 41 of the first gear train 4 and the input gear 61 of the third gear train 6, and the first synchronizer 71 is configured to cause at most one of the input gear 41 of the first gear train 4 and the input gear 61 of the third gear train 6 to be connected to the first input shaft 31.

In the above implementations, the first gear train 4 and the third gear train 6 are connected to the first input shaft 31 and the output shaft 32 simultaneously, and the first synchronizer 71 is disposed between the first gear train 4 and the third gear train 6. In this way, in the case that the first synchronizer 71 moves to one place and is engaged with the input gear 41 of the first gear train 4, the first gear train 4 is connected to the first input shaft 31, such that the power of the engine 1 is transmitted to the output shaft 32 through the first gear train 4. Meanwhile, in the case that the first synchronizer 71 moves to another place and is engaged with the input gear 61 of the third gear train 6, the third gear train 6 is connected to the first input shaft 31, such that the power of the engine 1 is transmitted to the output shaft 32 through the third gear train 6, and the engine 1 drives the vehicle in two gears.

In some embodiments, as shown in FIG. 3, the second speed change mechanism includes a second gear train 5, wherein an input gear 51 of the second gear train 5 is coaxially connected to the second input shaft 33, and an output gear 52 of the second gear train 5 is coaxially connected to the output shaft 32.

The second motor 22 is drivingly connected to the second input shaft 33, and the second input shaft 33 is drivingly connected to the output shaft 32 via the second gear train 5, such that the second motor 22 transmits power to the output shaft 32 only through the second gear train 5 to drive the wheels.

In some embodiments, as shown in FIG. 3, the first input shaft 31 is coaxially spaced from the second input shaft 33, and the second speed change mechanism B further includes a support shaft 91, wherein a first end of the support shaft 91 is movably connected to a first end of the first input shaft 31 in the circumferential direction, a second end of the first input shaft 31 is drivingly connected to the engine 1, and a second end of the support shaft 91 is coaxially connected to the second input shaft 33; and the input gear 61 of the third gear train 6 is sleeved on the support shaft 91.

Exemplarily, as shown in FIG. 3, a sleeve coaxially connected to the support shaft 91 is arranged at the first end of the support shaft 91, one end of the sleeve is open, and one end of the sleeve is opposite to the first end of the first input shaft 31. During assembly, the first end of the first input shaft 31 is coaxially inserted into the sleeve of the support shaft 91 to achieve the circumferential movable connection between the first input shaft 31 and the support shaft 91.

In some embodiments, a bearing is disposed in the sleeve, an outer ring of the bearing is connected to an inner wall of the sleeve, and an inner ring of the bearing is configured to be sleeved on the first input shaft 31, such that the first input shaft 31 rotates more stably in the sleeve, and the connection stability between the first input shaft 31 and the support shaft 91 is improved.

In the above implementations, the support shaft 91 is arranged, in the case that the support shaft 91 is connected to the first input shaft 31, the first input shaft 31 and the support shaft 91 form a whole portion, and both ends of the whole portion are supported by the engine 1 and the second motor 22 respectively. Therefore, the first end of the first input shaft 31 is prevented from being additionally provided with a supporting structure to support the first input shaft 31, such that the cost is saved, the axial size of the hybrid power system is reduced, and the hybrid power system is more compact and lightweight.

Meanwhile, the connection position of the first input shaft 31 and the support shaft 91 is in an inner hole of the input gear 61 of the third gear train 6, such that the first input shaft 31 and the support shaft 91 are not easy to separate and fall off upon being assembled. Meanwhile, the sleeve is arranged in the inner hole of the input gear 61 of the third gear train 6, which avoids occupying excessive internal space of the vehicle and makes the structure of the hybrid power system more compact.

In the embodiments of the present disclosure, the third gear train 6 at least includes an input gear and an output gear, and the input gear is drivingly connected to the output gear, such that the power is transmitted to the output gear through the input gear.

In some embodiments, in the third gear train 6, the input gear and the output gear are directly engaged. In some embodiments, at least one connecting gear is arranged between the input gear and the output gear.

It should be noted that the specific quantity of gears to be arranged in the third gear train 6 is determined according to actual demands.

In some embodiments, as shown in FIG. 3, the second speed change mechanism further includes a clutch 92, wherein the clutch 92 is disposed between the input gear 51 of the second gear train 5 and the second motor 22.

The arrangement of the clutch 92 between the second motor 22 and the input gear 51 of the second gear train 5 interrupts the power transmission path therebetween. In the case that only the engine 1 needs to work, the power of the engine 1 is not transmitted to the second motor 22 through the second gear train 5 to drag the second motor 22 to rotate, and thus the power loss is avoided.

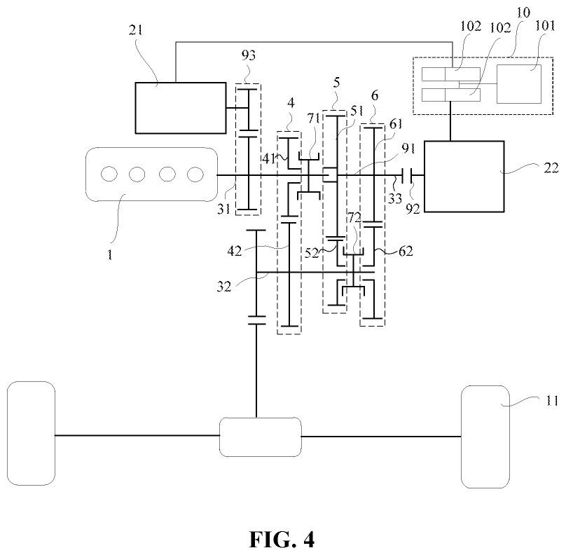

FIG. 4 is a schematic structural diagram of a hybrid power system according to some embodiments of the present disclosure. As shown in FIG. 4, the second speed change mechanism includes a second gear train 5, a third gear train 6, and a second synchronizer 72.

As shown in FIG. 4, an input gear 51 of the second gear train 5 and an input gear 61 of the third gear train 6 are coaxially connected to the second input shaft 33, and an output gear 52 of the second gear train 5 and an output gear 62 of the third gear train 6 are sleeved on the output shaft 32.

The first input shaft 31 is coaxially spaced from the second input shaft 33, and the first synchronizer 71 is configured to cause at most one of the input gear 41 of the first gear train 4 and the input gear 51 of the second gear train 5 to be connected to the first input shaft 31.

As shown in FIG. 4, the second synchronizer 72 is sleeved on the output shaft 32, and the second synchronizer 72 is configured to be drivingly connected to at most one of the output gear 52 of the second gear train 5 and the output gear 62 of the third gear train 6.

In the above implementations, the first synchronizer 71 is connected to the input gear 41 of the first gear train 4 or the input gear 51 of the second gear train 5, such that the kinetic energy output by the engine 1 can be transmitted to the output shaft 32 through the first gear train 4 and the second gear train 5, respectively, and thus the engine 1 can drive the vehicle in two gears.

The input gear 51 of the second gear train 5 is coaxially connected to the second input shaft 33, in the case that the first synchronizer 71 is connected to the input gear 51 of the second gear train 5, the first input shaft 31 is drivingly connected to the second input shaft 33. That is, the power of the engine 1 is also transmitted to the second input shaft 33, and the power of the engine 1 is transmitted to the output shaft 32 through the third gear train 6 in addition to the power of the engine 1 being transmitted to the output shaft 32 through the second gear train 5, such that the engine 1 is additionally provided with a gear, and the engine 1 can drive the vehicle in three gears.

Exemplarily, in the case that the engine 1 drives the vehicle in the first gear, the first synchronizer 71 is connected to the input gear 41 of the first gear train 4, and the power of the engine 1 is transmitted to the output shaft 32 through the first gear train 4 to drive the vehicle.

Exemplarily, in the case that the engine 1 drives the vehicle in the second gear, the first synchronizer 71 is connected to the input gear 51 of the second gear train 5, and the second synchronizer 72 is connected to the output gear 52 of the second gear train 5, and the power of the engine 1 is transmitted to the output shaft 32 through the second input shaft 33 and the second gear train 5 to drive the vehicle.

Exemplarily, in the case that the engine 1 drives the vehicle in the third gear, the first synchronizer 71 is connected to the input gear 51 of the second gear train 5, and the second synchronizer 72 is connected to the output gear 62 of the third gear train 6, and the power of the engine 1 is transmitted to the output shaft 32 through the second input shaft 33 and the third gear train 6 to drive the vehicle.

In some embodiments, as shown in FIGS. 2 and 3, the hybrid power system further includes a fourth gear train 93, wherein the first motor 21 is coaxially connected to an input gear of the fourth gear train 93, an output gear of the fourth gear train 93 is coaxially connected to the first input shaft 31, and the input gear of the fourth gear train 93 is disposed between the engine 1 and the input gear 41 of the first gear train 4.

The first motor 21 is connected to the first input shaft 31 via the fourth gear train 93, such that the power of the second motor 22 is transmitted to the first input shaft 31. The arrangement of the first motor 21 assists the engine 1 to drive the vehicle together so as to provide sufficient power for the vehicle.

Meanwhile, the first motor 21, like the engine 1, transmits power to the output shaft 32 through the first gear train 4 or the second gear train 5 by switching of the first synchronizer 71. Thus, the vehicle is driven in two gears.

In the embodiments of the present disclosure, the fourth gear train 93 at least includes an input gear and an output gear, and the input gear is drivingly connected to the output gear, such that the power is transmitted to the output gear through the input gear.

In some embodiments, in the fourth gear train 93, the input gear and the output gear are directly engaged. In some embodiments, at least one connecting gear is arranged between the input gear and the output gear.

It should be noted that the specific quantity of gears to be arranged in the fourth gear train 93 is determined based on actual demands.

In some embodiments, as shown in FIGS. 2 and 3, a power supply assembly 10 includes a battery 101 and two inverters 102, wherein the two inverters 102 are connected to the battery 101. The first motor 21 is connected to one of the two inverters 102, and the second motor 22 is connected to the other of the two inverters 102.

The two inverters 102 are arranged, one of the two inverters is configured to cause the battery 101 to be connected to the first motor 21, and the other inverter is configured to cause the battery 101 to be connected to the second motor 22. The battery 101 is a rechargeable battery 101, and the inverter 102 is arranged on an output circuit of the battery 101 and is configured to convert a direct current output by the battery 101 into a three-phase alternating current to drive the first motor 21 or the second motor 22.

The embodiments of the present disclosure provide a control method for the hybrid power system described above. The control method includes:
controlling a first speed change mechanism to cause a first input shaft to be connected to an output shaft, controlling a second speed change mechanism to cause a second input shaft to be disconnected from the output shaft, and controlling at least one of an engine and a first motor to rotate; or
controlling the first speed change mechanism to cause the first input shaft to be disconnected from the output shaft, controlling the second speed change mechanism to cause the second input shaft to be connected to the output shaft, and controlling the second motor to rotate.

In this way, the kinetic energy output by the engine and the two motors is transmitted to the output shaft through the two speed change mechanisms, such that the purpose of driving a vehicle to travel is achieved. In the single motor mode that only a motor needs to work, the two speed change mechanisms are controlled to achieve the purpose of working only by the second motor, and the power of the second motor is directly transmitted to the second input shaft, thus the engine and the first motor are not directly dragged by the second input shaft to rotate, and the energy loss is avoided, thereby increasing the transmission efficiency.

In some embodiments, the hybrid power system also controls the operation of the power source of the vehicle based on the power mode. The specific control method includes determining a power mode; and controlling the working states of the engine, the first motor and the second motor based on the power mode.

In the embodiments of the present disclosure, the power mode of the hybrid power system includes an electric-only mode, an engine-only mode, a hybrid mode, or a power recovery mode.

In the hybrid power system shown in FIG. 2, the engine, the first motor, the second motor and the first synchronizer operate in the following working states in different power modes.

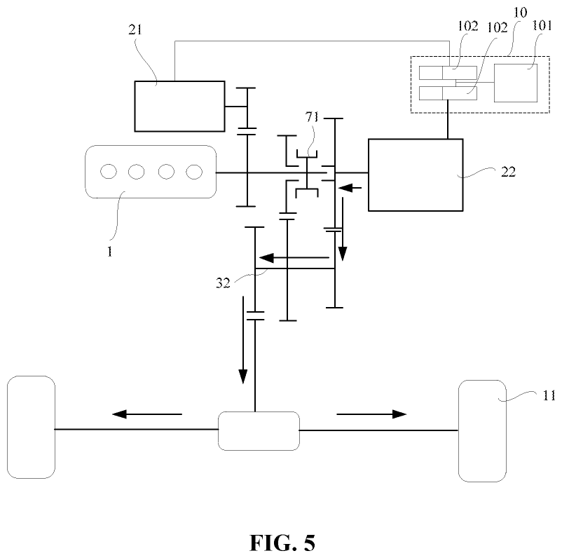

FIG. 5 is a schematic diagram of the power transfer of a hybrid power system in an electric-only mode according to some embodiments of the present disclosure. As shown in FIG. 5, in the case that the power mode of the hybrid power system is an electric-only mode, the engine 1 and the first motor 21 do not operate, and the first synchronizer 71 is not connected to the input gear 41 of the first gear train 4 and the input gear 51 of the second gear train 5, while the second motor 22 operates.

In this way, the engine 1 and the first motor 21 do not operate, the first synchronizer 71 is in the neutral position, and the vehicle is driven to travel by the second motor 22. The power supply assembly 10 discharges, the direct current is converted into a three-phase alternating current through the inverter 102 to drive the output shaft of the second motor 22 to rotate, the second motor 22 converts the electric energy into the mechanical energy, and the mechanical energy is transmitted to the wheels 11 through the second gear train 5, the output shaft 32 and the differential, such that the mode of driving the vehicle to travel by the second motor 22 alone is achieved.

In some embodiments, the vehicle is also driven in reverse gear by the second motor 22 in the electric-only mode. During reverse, the engine 1 and the first motor 21 do not operate, and the second motor 22 anticlockwise rotates to achieve reverse. In this mode, the energy transfer path is seen in FIG. 4.

In some embodiments, in the case that the power mode of the hybrid power system is an engine-only mode, the engine 1 operates, the first motor 21 and the second motor 22 do not operate, and the first synchronizer 71 is connected to the input gear 41 of the first gear train 4 or the input gear 51 of the second gear train 5.

At the moment, the first synchronizer 71 is in the left or right position, and the vehicle is driven to travel by the engine 1. The torque of the engine 1 is transmitted to the output shaft 32 through the first gear train 4 or the second gear train 5, and the mode of driving the vehicle to travel in two gears by the engine 1 is achieved.

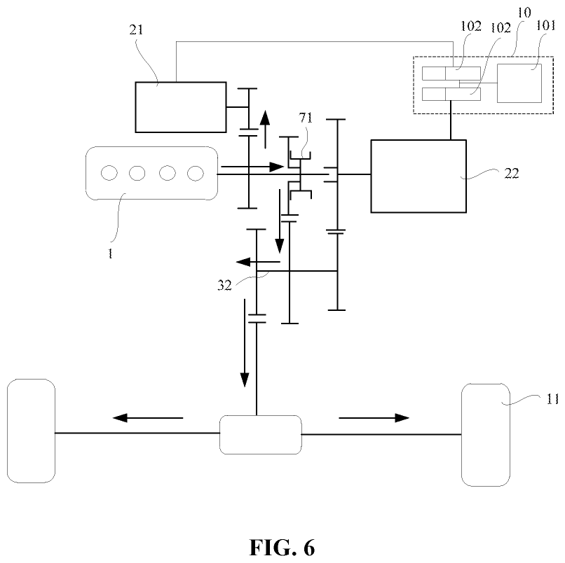

Taking the first synchronizer 71 moving to the left position as an example, FIG. 6 is a schematic diagram of the power transfer of a hybrid power system in an engine-only mode according to some embodiments of the present disclosure. As shown in FIG. 6, the first gear train 4 is connected to the first input shaft 31, and the torque of the engine 1 is transmitted to the wheels 11 through the first gear train 4, the output shaft 32 and the differential, such that the mode of driving the vehicle to travel by the engine 1 alone is achieved.

Exemplarily, at the moment, the engine 1 also drives the first motor 21 to rotate, so as to cause the first motor 21 to enter a power generation state to charge the power supply assembly 10.

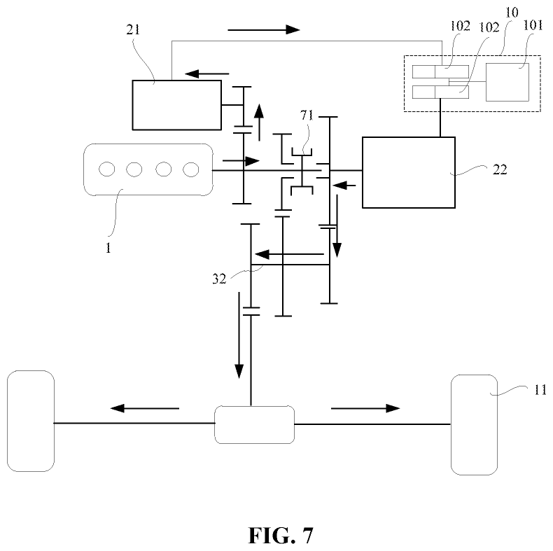

FIG. 7 is a schematic diagram of the power transfer of a hybrid power system in a hybrid mode according to some embodiments of the present disclosure. As shown in FIG. 7, in the case that the power mode of the hybrid power system is a hybrid mode, the engine 1 drives the first motor 21 to generate electricity, and the first synchronizer 71 is not connected to the input gear 41 of the first gear train 4 and the input gear 51 of the second gear train 5, while the second motor 22 operates.

In this way, the first synchronizer 71 is in a neutral position, the engine 1 operates in a high-efficiency area to drive the first motor 21 to generate electricity, the generated electricity is supplied to the second motor 22 to drive the vehicle to travel, and excess electricity is stored in the power supply assembly 10. In the case that the power generation amount is insufficient and is supplemented by the power supply assembly 10, the first motor 21 and the power supply assembly 10 jointly meet the electric quantity demand of the second motor 22. As shown in FIG. 7, the power output by the second motor 22 is transmitted to the wheels 11 through the second gear train 5, the output shaft 32 and the differential to drive the vehicle to travel.

In some embodiments, in the case that the power mode of the hybrid power system is a hybrid mode, the engine 1 and the first motor 21 operate, and the first synchronizer 71 is connected to the input gear 41 of the first gear train 4 or the input gear 51 of the second gear train 5, while the second motor 22 operates.

In this way, the first synchronizer 71 is in the left or right position, and the engine 1, the second motor 22 and the first motor 21 jointly drive the vehicle to travel. The torque of the engine 1 and the first motor 21 is transmitted to the output shaft 32 through the first gear train 4 or the second gear train 5, and the torque of the second motor 22 is transmitted to the output shaft 32 through the second gear train 5, such that the mode of jointly driving the vehicle by the engine 1 and the two motors is achieved.

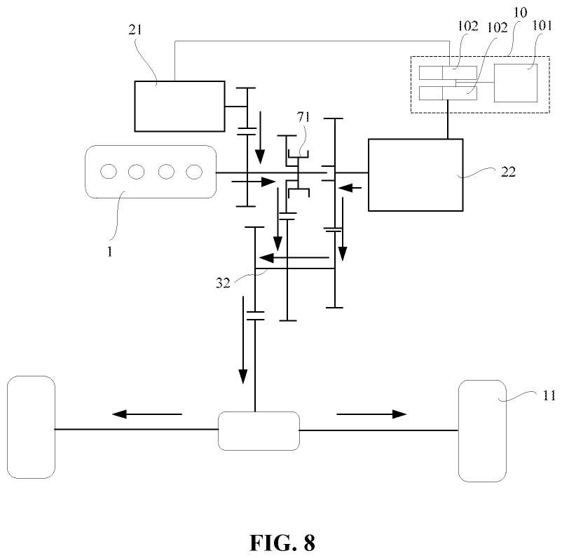

Taking the first synchronizer 71 moving to the left position as an example, FIG. 8 is a schematic diagram of the power transfer of a hybrid power system in a hybrid mode according to some embodiments of the present disclosure. As shown in FIG. 8, the first gear train 4 is connected to the first input shaft 31, the torque of the engine 1 and the first motor 21 is transmitted to the wheels 11 through the first gear train 4, the output shaft 32 and the differential, and the torque of the first motor 21 is transmitted to the wheels 11 through the second gear train 5, the output shaft 32 and the differential, so as to achieve the purpose of jointly driving the vehicle to travel by the three power sources.

In this mode, the power of the engine 1 and the first motor 21 is transmitted out of the output shaft 32 through the first gear train 4. The power of the second motor 22 is transmitted to the output shaft 32 through the second gear train 5. The engine 1, the first motor 21 and the second motor 22 transmit power to the output shaft 32 through two gear trains, so another gear is used to drive the vehicle, improving the use efficiency of the gear trains, and realizing a multi-gear driving mode of the hybrid power system.

In some embodiments, in the case that the power mode of the hybrid power system is a hybrid mode, the engine 1 and the first motor 21 operate, and the first synchronizer 71 is connected to the input gear 41 of the first gear train 4 or the input gear 51 of the second gear train 5, while the second motor 22 does not operate.

In this way, the first synchronizer 71 is in the left or right position, and the vehicle is driven to travel by the engine 1 and the first motor 21 together. The power supply assembly 10 discharges, the direct current is converted into a three-phase alternating current through the inverter 102 to drive the first motor 21 to rotate, and the first motor 21 is in a power generation or electric state according to the vehicle speed and torque requirements. The torque of the engine 1 and the first motor 21 is transmitted to the wheels 11 through the first gear train 4 or the second gear train 5, the output shaft 32 and the differential, and the mode of jointly driving the vehicle to travel in two gears by two power sources is achieved.

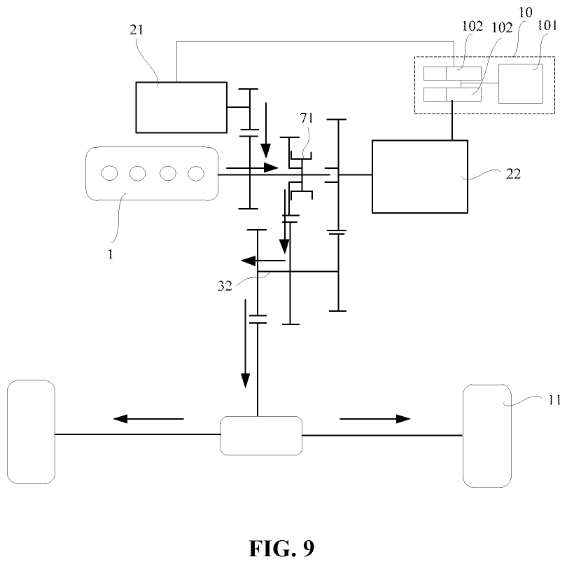

Taking the first synchronizer 71 moving to the left position as an example, FIG. 9 is a schematic diagram of the power transfer of a hybrid power system in a hybrid mode according to some embodiments of the present disclosure. As shown in FIG. 9, the engine 1 and the first motor 21 operate, while the second motor 22 does not operate, the vehicle is driven to start and travel by the power supplied from the engine 1, and the first motor 21 operates in a power generation or electric mode according to the vehicle speed and torque requirements.

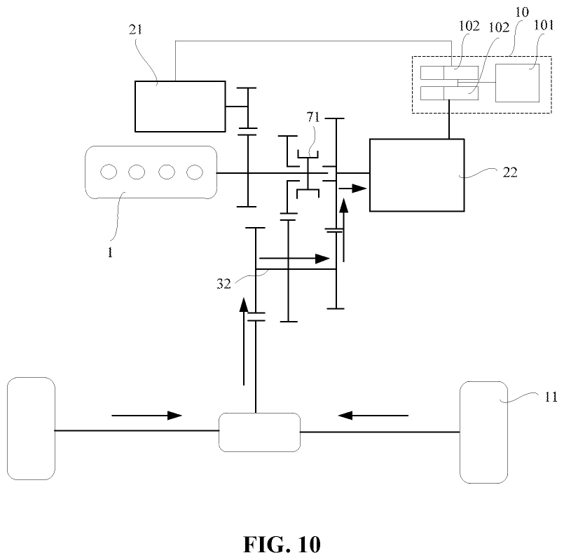

FIG. 10 is a schematic diagram of the power transfer of a hybrid power system in a power recovery mode according to some embodiments of the present disclosure. As shown in FIG. 10, in the case that the power mode of the hybrid power system is an energy recovery mode, the engine 1 and the first motor 21 do not operate, and the first synchronizer 71 is not connected to the input gear 41 of the first gear train 4 and the input gear 51 of the second gear train 5, while the second motor 22 generates electricity.

In this mode, the vehicle is in a coasting or braking condition, the wheels 11 provide reverse torque, and a part of kinetic energy of the vehicle is transmitted to the second motor 22 through the differential, the output shaft 32 and the second gear train 5 to be converted into electric energy, which is stored in the power supply assembly 10 for later use, so as to achieve the energy recovery function of the second motor 22.

In the hybrid power system shown in FIG. 3, the engine, the first motor, the second motor and the first synchronizer operate in the following working states in different power modes.

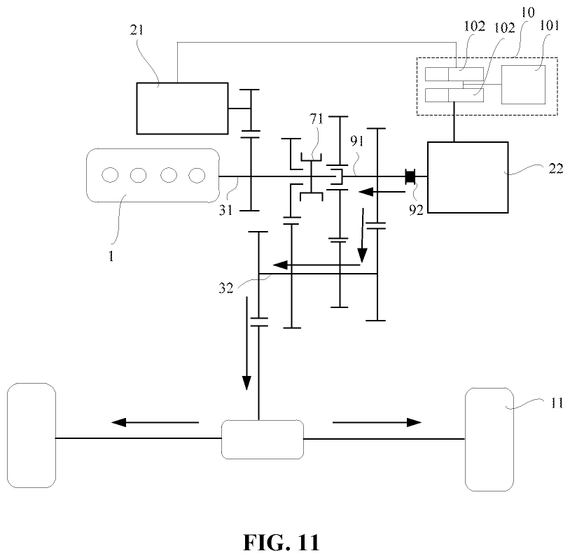

FIG. 11 is a schematic diagram of the power transfer of a hybrid power system in an electric-only mode according to some embodiments of the present disclosure. As shown in FIG. 11, in the case that the power mode of the hybrid power system is an electric-only mode, the engine 1 and the first motor 21 do not operate, and the first synchronizer 71 is not connected to the input gear 41 of the first gear train 4 and the input gear 51 of the second gear train 5, while the second motor 22 operates, and the clutch 92 is engaged.

In this way, the engine 1 and the first motor 21 do not operate, the first synchronizer 71 is in the neutral position, the clutch 92 is engaged, and the vehicle is driven to travel by the second motor 22. The power supply assembly 10 discharges, the direct current is converted into a three-phase alternating current through the inverter 102 to drive the output shaft of the second motor 22 to rotate, the second motor 22 converts the electric energy into the mechanical energy, and the mechanical energy is transmitted to the wheels 11 through the clutch 92, the third gear train 6, the output shaft 32 and the differential, such that the mode of driving the vehicle to travel by the second motor 22 alone is achieved.

In some embodiments, the vehicle is also driven in reverse gear by the second motor 22 in the electric-only mode. During reverse, the engine 1 and the first motor 21 do not operate, and the second motor 22 anticlockwise rotates to achieve reverse. In this mode, the energy transfer path is seen in FIG. 10.

In some embodiments, in the case that the power mode of the hybrid power system is an engine-only mode, the engine 1 operates, the second motor 22 and the first motor 21 do not operate, the first synchronizer 71 is connected to the input gear 41 of the first gear train 4 or the input gear 51 of the second gear train 5, and the clutch 92 is disengaged.

In this way, the first synchronizer 71 is in the left or right position, the clutch 92 is disengaged, and the vehicle is driven to travel by the engine 1. The torque of the engine 1 is transmitted to the output shaft 32 through the first gear train 4 or the second gear train 5, and the mode of driving the vehicle to travel in two gears by the engine 1 is achieved.

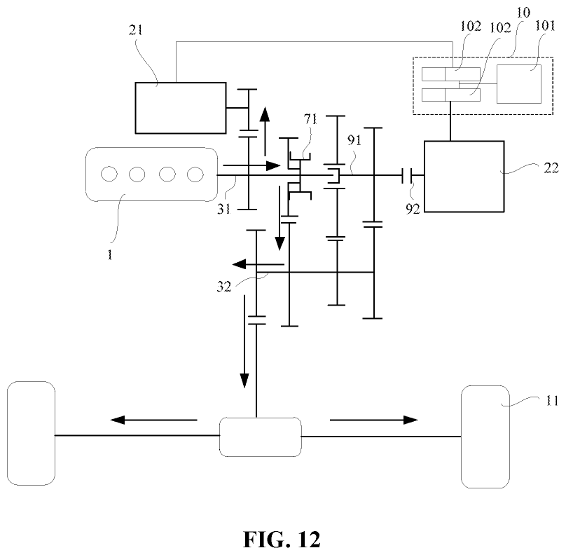

Taking the first synchronizer 71 moving to the left position as an example, FIG. 12 is a schematic diagram of the power transfer of a hybrid power system in an engine-only mode according to some embodiments of the present disclosure. As shown in FIG. 12, the first gear train 4 is connected to the first input shaft 31, and the torque of the engine 1 is transmitted to the wheels 11 through the first gear train 4, the output shaft 32 and the differential, such that the mode of driving the vehicle to travel by the engine 1 alone is achieved.

Exemplarily, at the moment, the engine 1 also drives the first motor 21 to rotate, so as to cause the first motor 21 to enter a power generation state to charge the power supply assembly 10.

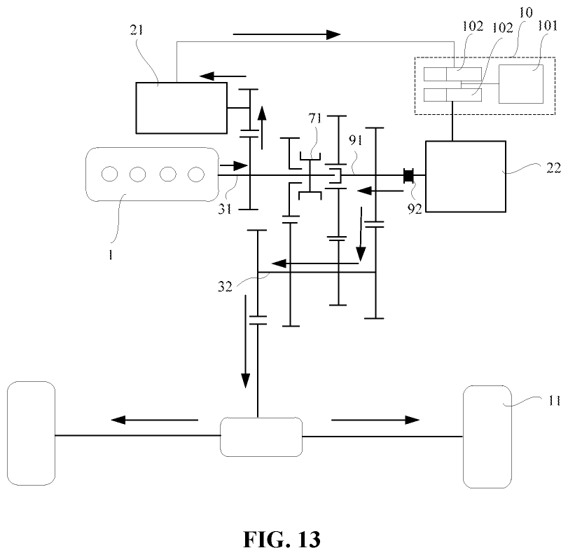

FIG. 13 is a schematic diagram of the power transfer of a hybrid power system in a hybrid mode according to some embodiments of the present disclosure. As shown in FIG. 13, in the case that the power mode of the hybrid power system is a hybrid mode, the engine 1 drives the first motor 21 to generate electricity, and the first synchronizer 71 is not connected to the input gear 41 of the first gear train 4 and the input gear 51 of the second gear train 5, while the second motor 22 operates, and the clutch 92 is engaged.

In this way, the first synchronizer 71 is in a neutral position, the clutch 92 is engaged, the engine 1 operates in a high-efficiency area to drive the first motor 21 to generate electricity, the generated electricity is supplied to the second motor 22 to drive the vehicle to travel, and excess electricity is stored in the power supply assembly 10. In the case that the power generation amount is insufficient and is supplemented by the power supply assembly 10, the first motor 21 and the power supply assembly 10 jointly meet the electric quantity demand of the second motor 22. As shown in FIG. 12, the power output by the second motor 22 is transmitted to the wheels 11 through the clutch 92, the third gear train 6, the output shaft 32 and the differential to drive the vehicle to travel.

In some embodiments, in the case that the power mode of the hybrid power system is a hybrid mode, the engine 1 and the first motor 21 operate, and the first synchronizer 71 is connected to the input gear 41 of the first gear train 4 or the input gear 51 of the second gear train 5, while the second motor 22 operates, and the clutch 92 is engaged.

In this way, the first synchronizer 71 is in the left or right position, the clutch 92 is engaged, and the vehicle is driven to travel by the engine 1, the second motor 22 and the first motor 21 together. The torque of the engine 1 and the first motor 21 is transmitted to the output shaft 32 through the first gear train 4 or the second gear train 5, the torque of the second motor 22 is transmitted to the output shaft 32 through the clutch 92 and the third gear train 6, and the mode of driving the vehicle to travel by the engine 1 and the two motors together is achieved.

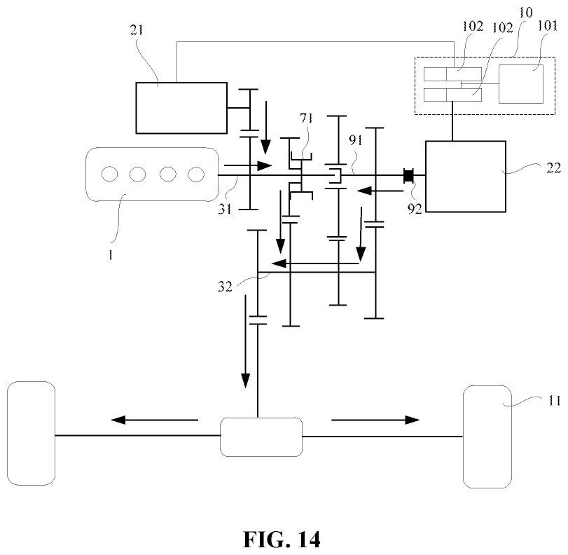

Taking the first synchronizer 71 moving to the left position as an example, FIG. 14 is a schematic diagram of the power transfer of a hybrid power system in a hybrid mode according to some embodiments of the present disclosure. As shown in FIG. 14, the first gear train 4 is connected to the first input shaft 31, at the moment, the torque of the engine 1 and the first motor 21 is transmitted to the wheels 11 through the first gear train 4, the output shaft 32 and the differential, and the torque of the first motor 21 is transmitted to the wheels 11 through the clutch 92, the third gear train 6, the output shaft 32 and the differential, so as to achieve the purpose of jointly driving the vehicle to travel by the three power sources.

In this mode, the power of the engine 1 and the first motor 21 is transmitted out of the output shaft 32 through the first gear train 4, and the power of the second motor 22 is transmitted to the output shaft 32 through the third gear train 6. The engine 1, the first motor 21 and the second motor 22 transmit power to the output shaft 32 through two gear trains, improving the use efficiency of the gear trains, and realizing a multi-gear driving mode of the hybrid power system.

In some embodiments, in the case that the power mode of the hybrid power system is the hybrid mode, the engine 1 and the first motor 21 operate, and the first synchronizer 71 is connected to the input gear 41 of the first gear train 4 or the input gear 51 of the second gear train 5, while the second motor 22 does not operate, and the clutch 92 is disengaged.

In this way, the first synchronizer 71 is in the left or right position, and the vehicle is driven to travel by the engine 1 and the first motor 21 together. The power supply assembly 10 discharges, the direct current is converted into a three-phase alternating current through the inverter 102 to drive the first motor 21 to rotate, and the first motor 21 is in a power generation or electric state according to the vehicle speed and torque requirements. The torque of the engine 1 and the first motor 21 is transmitted to the wheels 11 through the first gear train 4 or the second gear train 5, the output shaft 32 and the differential, and the mode of jointly driving the vehicle to travel in two gears by two power sources is achieved.

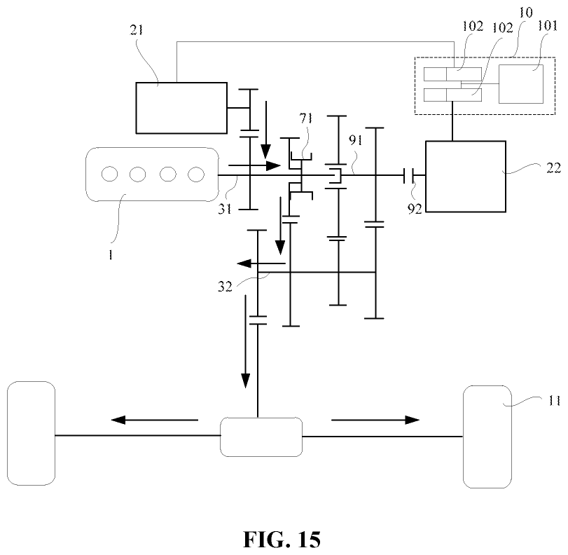

Taking the first synchronizer 71 moving to the left position as an example, FIG. 15 is a schematic diagram of the power transfer of a hybrid power system in a hybrid mode according to some embodiments of the present disclosure. As shown in FIG. 15, the engine 1 and the first motor 21 operate, while the second motor 22 does not operate, the vehicle is driven to start and travel by the power supplied from the engine 1, and the first motor 21 operates in a power generation or electric mode according to the vehicle speed and torque requirements.

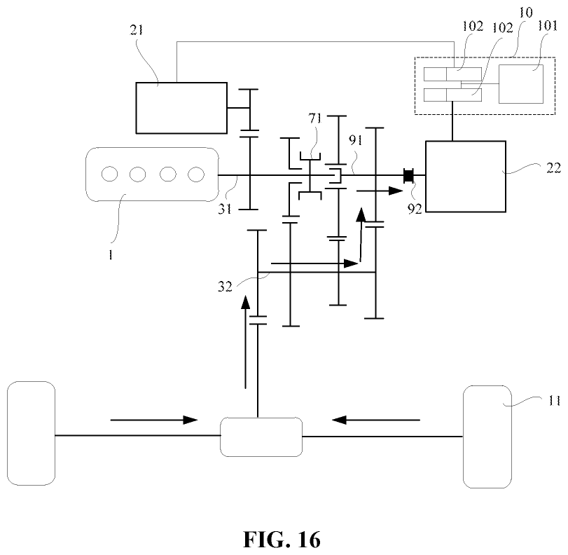

FIG. 16 is a schematic diagram of the power transfer of a hybrid power system in a power recovery mode according to some embodiments of the present disclosure. As shown in FIG. 16, in the case that the power mode of the hybrid power system is an energy recovery mode, the engine 1 and the first motor 21 do not operate, and the first synchronizer 71 is not connected to the input gear 41 of the first gear train 4 and the input gear 51 of the second gear train 5, while the second motor 22 generates electricity, and the clutch 92 is engaged.

In this mode, in the case that the vehicle is in a coasting or braking condition, the wheels 11 provide reverse torque, and a part of kinetic energy of the vehicle is transmitted to the second motor 22 through the differential, the output shaft 32, the third gear train 6 and the clutch 92 to be converted into electric energy, which is stored in the power supply assembly 10 for later use, so as to achieve the energy recovery function of the second motor 22.

The above description does not limit the present disclosure in any way. Although the present disclosure has been described as above through the embodiments, they are not intended to limit the present disclosure. Those skilled in the art are able to make some changes or modifications to the above disclosed technical contents to give equivalent embodiments of equivalent changes without departing from the scope of the present disclosure. However, any simple alterations, equivalent changes and modifications made, without departing from the contents of the technical solutions of the present disclosure, on the above embodiments based on the technical essence of present disclosure shall fall within the scope of the technical solutions of the present disclosure.

1. A hybrid power system, comprising:
a gearbox;
an engine;
a first motor; and
a second motor;
wherein the gearbox comprises a first input shaft, an output shaft, a second input shaft, a first speed change mechanism, and a second speed change mechanism, wherein the first input shaft is connected to the output shaft via the first speed change mechanism, and the second input shaft is connected to the output shaft via the second speed change mechanism;
wherein the engine and the first motor are drivingly connected to the first input shaft; and
wherein the second motor is drivingly connected to the second input shaft.

2. The hybrid power system according to claim 1, wherein the first speed change mechanism comprises a first gear train and a first synchronizer;
wherein an input gear of the first gear train is sleeved on the first input shaft, and an output gear of the first gear train is coaxially connected to the output shaft; and
wherein the first synchronizer is sleeved on the first input shaft, and the first synchronizer is configured to cause the input gear of the first gear train to be connected to the first input shaft or cause the input gear of the first gear train to be disconnected from the first input shaft.

3. The hybrid power system according to claim 2, wherein the second speed change mechanism comprises a second gear train, wherein an input gear of the second gear train is coaxially connected to the second input shaft, and an output gear of the second gear train is coaxially connected to the output shaft; and
the first input shaft is coaxially spaced from the second input shaft, the input gear of the second gear train is disposed at one end of the second input shaft opposite to the first input shaft, and the first synchronizer is configured to cause at most one of the input gear of the first gear train and the input gear of the second gear train to be connected to the first input shaft.

4. The hybrid power system according to claim 2, wherein the first speed change mechanism further comprises a third gear train, wherein an input gear of the third gear train is sleeved on the first input shaft, and an output gear of the third gear train is coaxially connected to the output shaft; and
wherein the first synchronizer is disposed between the input gear of the first gear train and the input gear of the third gear train, and the first synchronizer is configured to cause at most one of the input gear of the first gear train and the input gear of the third gear train to be connected to the first input shaft.

5. The hybrid power system according to claim 4, wherein the second speed change mechanism comprises a second gear train, wherein an input gear of the second gear train is coaxially connected to the second input shaft, and an output gear of the second gear train is coaxially connected to the output shaft.

6. The hybrid power system according to claim 5, wherein the first input shaft is coaxially spaced from the second input shaft; and
wherein the second speed change mechanism further comprises a support shaft, wherein a first end of the support shaft is movably connected to a first end of the first input shaft in a circumferential direction, a second end of the first input shaft is drivingly connected to the engine, and a second end of the support shaft is coaxially connected to the second input shaft; and the input gear of the third gear train is sleeved on the support shaft.

7. The hybrid power system according to claim 6, wherein a sleeve coaxially connected to the support shaft is arranged at the first end of the support shaft, one end of the sleeve is open, and the sleeve is opposite to the first end of the first input shaft; and
wherein a bearing is arranged in the sleeve, wherein an outer ring of the bearing is connected to an inner wall of the sleeve, and an inner ring of the bearing is sleeved on the first end of the first input shaft.

8. The hybrid power system according to claim 5, wherein the second speed change mechanism further comprises a clutch, wherein the clutch is disposed between the input gear of the second gear train and the second motor.

9. The hybrid power system according to claim 2, wherein the second speed change mechanism comprises a second gear train, a third gear train, and a second synchronizer;
wherein an input gear of the second gear train and an input gear of the third gear train are both coaxially connected to the second input shaft, and an output gear of the second gear train and an output gear of the third gear train are sleeved on the output shaft;
wherein the first input shaft is coaxially spaced from the second input shaft, the first synchronizer is configured to cause at most one of the input gear of the first gear train and the input gear of the second gear train to be connected to the first input shaft; and
wherein the second synchronizer is sleeved on the output shaft, and the second synchronizer is configured to be drivingly connected to at most one of the output gear of the second gear train and the output gear of the third gear train.

10. The hybrid power system according to claim 1, wherein the gearbox further comprises a fourth gear train, wherein the first motor is coaxially connected to an input gear of the fourth gear train, and an output gear of the fourth gear train is coaxially connected to the first input shaft.

11. The hybrid power system according to claim 1, further comprising: a power supply assembly, wherein the power supply assembly comprises a battery and two inverters, the two inverters being connected to the battery, the first motor being connected to one of the two inverters, and the second motor being connected to the other of the two inverters.

12. A vehicle, comprising a hybrid power system,
wherein the hybrid power system comprises: a gearbox; an engine; a first motor; and a second motor;
wherein the gearbox comprises a first input shaft, an output shaft, a second input shaft, a first speed change mechanism, and a second speed change mechanism, wherein the first input shaft is connected to the output shaft via the first speed change mechanism, and the second input shaft is connected to the output shaft via the second speed change mechanism;
wherein the engine and the first motor are drivingly connected to the first input shaft; and
wherein the second motor is drivingly connected to the second input shaft.

13. The vehicle according to claim 12, wherein the first speed change mechanism comprises a first gear train and a first synchronizer;
wherein an input gear of the first gear train is sleeved on the first input shaft, and an output gear of the first gear train is coaxially connected to the output shaft; and
the first synchronizer is sleeved on the first input shaft, and the first synchronizer is configured to cause the input gear of the first gear train to be connected to the first input shaft or cause the input gear of the first gear train to be disconnected from the first input shaft.

14. The vehicle according to claim 13, wherein the second speed change mechanism comprises a second gear train, wherein an input gear of the second gear train is coaxially connected to the second input shaft, and an output gear of the second gear train is coaxially connected to the output shaft; and
wherein the first input shaft is coaxially spaced from the second input shaft, the input gear of the second gear train is disposed at one end of the second input shaft opposite to the first input shaft, and the first synchronizer is configured to cause at most one of the input gear of the first gear train and the input gear of the second gear train to be connected to the first input shaft.

15. The vehicle according to claim 13, wherein the first speed change mechanism further comprises a third gear train, wherein an input gear of the third gear train is sleeved on the first input shaft, and an output gear of the third gear train is coaxially connected to the output shaft; and
wherein the first synchronizer is disposed between the input gear of the first gear train and the input gear of the third gear train, and the first synchronizer is configured to cause at most one of the input gear of the first gear train and the input gear of the third gear train to be connected to the first input shaft.

16. The vehicle according to claim 15, wherein the second speed change mechanism comprises a second gear train, wherein an input gear of the second gear train is coaxially connected to the second input shaft, and an output gear of the second gear train is coaxially connected to the output shaft.

17. The vehicle according to claim 16, wherein the first input shaft is coaxially spaced from the second input shaft; and
wherein the second speed change mechanism further comprises a support shaft, wherein a first end of the support shaft is movably connected to a first end of the first input shaft in a circumferential direction, a second end of the first input shaft is drivingly connected to the engine, and a second end of the support shaft is coaxially connected to the second input shaft; and the input gear of the third gear train is sleeved on the support shaft.

18. The vehicle according to claim 17, wherein a sleeve coaxially connected to the support shaft is arranged at the first end of the support shaft, one end of the sleeve is open, and the sleeve is opposite to the first end of the first input shaft; and
wherein a bearing is arranged in the sleeve, wherein an outer ring of the bearing is connected to an inner wall of the sleeve, and an inner ring of the bearing is sleeved on the first end of the first input shaft.

19. The vehicle according to claim 16, wherein the second speed change mechanism further comprises a clutch, wherein the clutch is disposed between the input gear of the second gear train and the second motor.

20. The vehicle according to claim 13, wherein the second speed change mechanism comprises a second gear train, a third gear train, and a second synchronizer;
wherein an input gear of the second gear train and an input gear of the third gear train are both coaxially connected to the second input shaft, and an output gear of the second gear train and an output gear of the third gear train are sleeved on the output shaft;
wherein the first input shaft is coaxially spaced from the second input shaft, the first synchronizer is configured to cause at most one of the input gear of the first gear train and the input gear of the second gear train to be connected to the first input shaft; and
wherein the second synchronizer is sleeved on the output shaft, and the second synchronizer is configured to be drivingly connected to at most one of the output gear of the second gear train and the output gear of the third gear train.
